(19) United States
(12) Patent Application Publication
(10) Pub. No.: US 2026/0249786 A1
(43) Pub. Date: Aug. 27, 2026

(54) HOLDING DEVICE FOR A HOOK OF A LUGGAGE NET IN A MOTOR VEHICLE AND MOTOR VEHICLE

(71) Applicant: AUDI AG, Ingolstadt (DE)

(72) Inventor: Maximilian KÄTHLER, Ingolstadt (DE)

(73) Assignee: AUDI AG, Ingolstadt (DE)

(21) Appl. No.: 19/436,501

(22) Filed: Dec. 30, 2025

(30) Foreign Application Priority Data
Feb. 26, 2025 (DE) 102025107344.9

(51) Int. Cl. B60R 5/04; B60R 11/00

(52) U.S. Cl. CPC B60R 5/044; B60R 2011/0036; B60R 2011/0059; B60R 2011/0075

(57) ABSTRACT

A holding device for a motor vehicle, to which a hook of a luggage net for the motor vehicle can be attached. The holding device includes a base part and a cover part, the cover part is held on the base part and covers the base part at least in regions. The base part has a receiving region into which the hook of the luggage net can be inserted. The cover part has a holding web which surrounds at least in regions a passage opening formed in the cover part. To secure the luggage net to the holding device, the holding web can be engaged from behind by the hook of the luggage net.

### FIELD

The invention relates to a holding device for a motor vehicle, to which a hook of a luggage net for the motor vehicle can be attached. The holding device comprises a base part and a cover part, wherein the cover part is held on the base part. The cover part conceals the base part, at least in regions. The base part has a receiving region into which the hook of the luggage net can be inserted. Furthermore, the invention also relates to a motor vehicle having at least one such a holding device.

### BACKGROUND

Lashing rings can be used to secure the hooks of a luggage net, for example in the cargo space of a motor vehicle, if such lashing rings are available in the cargo space. Such lashing rings can be designed to withstand a load with a comparatively large force of, for example, 6 kN. However, it is sometimes difficult to provide attachment points in the cargo space of the vehicle for such lashing rings that have a sufficiently high load-bearing capacity. Particularly when the lashing ring is fixed to a component of the vehicle body shell, it presents a challenge to ensure that the body shell has the desired load-bearing capacity at the location intended for the lashing ring.

CN 207106358 U describes a hook arrangement for a motor vehicle, which has a base and a pivoting cover plate. When the cover plate is pivoted into an open position, a handle part of the hook arrangement is accessible, which is received in a receiving space of the base. The handle can be folded down around another pivot axis. Then a hook of a luggage net can be attached in an opening which is formed in the handle part.

Such a hook arrangement is comparatively complex in terms of operation. To attach the hook, the cover plate must first be folded up and then the handle part folded down.

Furthermore, CN 113581093 A describes a hook which is arranged in a receiving space of an aperture and is accessible via the receiving space. A front opening in the panel can be closed using a cover plate. When the cover plate is in a closed position, the cover plate is locked onto the aperture.

### SUMMARY

The object of the present invention is to provide a holding device of the type mentioned at the outset, which is particularly easy to use, and to specify a motor vehicle with at least one such holding device.

This object is achieved by a holding device and by a motor vehicle. Advantageous embodiments having expedient developments of the invention are specified in the claims and in the following description.

The holding device according to the invention for a motor vehicle, to which a hook of a luggage net for the motor vehicle can be attached, comprises a base part and a cover part. In this case, the cover part is held on the base part, and the cover part conceals the base part at least in regions. The base part has a receiving region into which the hook of the luggage net can be inserted. The cover part has a holding web which surrounds at least in regions a passage opening formed in the cover part. To secure the luggage net to the holding device, the holding web can be engaged from behind by the hook of the luggage net.

To use the holding device for attaching the hook of the luggage net, it is therefore only necessary to insert the hook into the receiving space of the base part, wherein the holding web of the cover part can then be gripped from behind by the hook. The holding web of the cover part thus prevents the hook from detaching from the holding device without the intervention of an operator. This is advantageous.

The holding device is particularly easy to use for attaching the hook of the luggage net. The function of the holding web is to enable the hooking or engaging from behind of the luggage net hook or a luggage net spider with corresponding hooks.

And since there is no lashing ring in the receiving region of the base part, the holding device cannot be misused to secure a lashing strap to such a ring. This is advantageous. This in fact means that the holding device does not need to be designed for forces such as those that can occur when tensioning a lashing strap on a lashing ring of a motor vehicle.

Furthermore, the holding device is particularly easy to install. During assembly, the cover part is secured to the base part, due to the cover part being held in place on the base part. And the base part, which has the receiving space, can in turn be mounted very easily and with little effort in the motor vehicle if the motor vehicle is to be equipped with the holding device.

Preferably, the cover part is held in place on the base part by a snap-fit mechanism. No tools are needed to attach the cover part to the base part. This facilitates easy assembly.

Preferably, the base part has at least one slot into which a holding tab of the cover part is inserted. In this case, the base part and the holding tab have corresponding locking elements, with the locking elements engaging with each other. Such a fixing or mounting of the cover part to the base part can be implemented very easily. During assembly, the insertion of the at least one holding tab of the cover part into the at least one slot of the base part ensures that the two locking elements engage with each other.

Preferably, the base part has a plurality of slots which are formed in an edge flange of the base part that surrounds the receiving space. In this case, the locking elements of the base part are arranged on an outside of a sleeve region of the base part, the sleeve region delimiting the receiving space of the base part in the circumferential direction. By forming the slots in the edge flange, the slots are well defined in their position and thus easily accessible for the corresponding holding tabs of the cover part.

And by providing the sleeve region, the base part is given an advantageously high stiffness. Furthermore, the locking elements of the base part can be provided very easily and with minimal effort on the outside of the sleeve region, especially if the locking elements are formed integrally with a base body of the base part.

Preferably, the cover part comprises a panel region covering the slots, wherein a partial region of a covering part for the motor vehicle is arranged between the edge flange of the base part and the panel region of the cover part. In this case, the partial region of the covering component located between the edge flange and the panel region runs around a receiving opening, the receiving opening being formed in the covering component. By positioning the partial region of the covering part between the edge flange of the base part and the panel region of the cover part, fixing the base part and the cover part to the partial region of the covering part becomes very easy. This is because when the holding tabs of the cover part are inserted into the slots of the base part, the partial region of the covering part which has the receiving opening is clamped between the edge flange and the panel region.

Such a fixation of the base part and the cover part to the covering part facilitates simplified assembly. This is because the holding device or a corresponding assembly, which includes the base part, the cover part and the covering part, can be delivered pre-assembled for further installation in the motor vehicle. Once the covering part is in its intended place in the vehicle, the base and cover parts of the holding device are also in place in the vehicle where these components are intended. This is advantageous.

Preferably, the holding web of the cover part runs completely around the passage opening formed in the cover part, with a free end of the hook being able to be inserted into a guide groove. Here, the guide groove is formed between the holding web and the sleeve region of the base part. This facilitates a very diverse use of the holding device. Because the hook can be attached at any point on the holding web that completely surrounds the passage opening. This allows the luggage net with the hook to be easily tensioned in any direction from the holding device. This is advantageous for versatile and flexible use of the luggage net in the motor vehicle.

Furthermore, the engagement of the free end of the hook in the guide groove is advantageous in order to move the hook along the guide groove to a specific point of the holding web surrounding the passage opening. This is advantageous in terms of easily attaching the hook to the holding web of the cover part.

The corresponding locking elements can comprise a locking opening formed in the holding tab and a locking lug arranged on the base part. This allows at least one holding tab to be inserted particularly easily into at least one slot provided on the base part.

Preferably, the receiving space of the base part is limited in an insertion direction in which the hook can be inserted into the receiving space by a bottom region of the base part. This contributes to the high robustness of the base part. This applies in particular when the sleeve region of the base part adjoins the bottom region of the base part towards the cover part.

Preferably, at least one fastening opening is formed in the bottom region of the base part, into which a fastening element can be inserted. In this case, the base part can be fixed to a component of the motor vehicle by means of the at least one fastening element. In this way, a very robust mounting of the base part and thus of the holding device on the component of the motor vehicle can be achieved.

For example, the fastening element can be designed as a screw which can be passed through the fastening opening and screwed into a screw opening which is formed in the component of the motor vehicle. Additionally or alternatively, at least one fastening element can be designed in the form of an expanding element and/or as a rivet or the like. This method also allows for a good and secure fixing of the base part to the component of the motor vehicle, which can be provided in particular by a raw component of the motor vehicle. Designing the component as a raw component of the motor vehicle is advantageous for a particularly robust fixing of the holding device in the motor vehicle.

The motor vehicle according to the invention has at least one holding device according to the invention. In this case, at least one receiving opening is formed in a covering part of the motor vehicle, wherein an edge of the receiving opening surrounds the receiving space of the base part of the at least one holding device in a circumferential direction. The holding device located in the at least one receiving opening can thus be used very easily and intuitively to hook the luggage net onto the holding web of the cover part. Consequently, at least one holding device in the motor vehicle is readily usable.

Preferably, the covering panel is designed as a side covering panel of a cargo space of the motor vehicle. This makes the holding web of the cover part particularly accessible to a user from the cargo space of the vehicle. The user can easily attach the hook of the luggage net to the holding web of the cover part by first inserting the hook into the receiving space of the base part.

The advantages and preferred embodiments described for the holding device according to the invention also apply to the motor vehicle according to the invention and vice versa.

The invention also includes developments of the motor vehicle according to the invention, which have features as already described in the context of the developments of the holding device according to the invention. For this reason, the corresponding developments of the motor vehicle according to the invention are not described again here.

The motor vehicle according to the invention is preferably designed as an automobile, in particular as a passenger car or truck, or as a passenger bus.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a partial view of a cargo space of a motor vehicle, wherein a holding device in a side covering part of the cargo space provides a possibility for attaching a hook of a luggage net for the motor vehicle (also shown in FIG. 1);

FIG. 2 shows a perspective exploded view of a base part and a cover part of the holding device;

FIG. 3 shows another perspective view of the base part and the cover part;

FIG. 4 shows a top view of the base part along an insertion direction into which the hook can be inserted into a receiving space of the base part;

FIG. 5 shows the base part of the holding device in a side view;

FIG. 6 shows a top view of a visible side of the cover part;

FIG. 7 shows the cover part according to FIG. 6 in a side view; and

FIG. 8 schematically shows the motor vehicle which has the at least one holding device in the cargo space.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, same reference numerals respectively designate elements that have the same function.

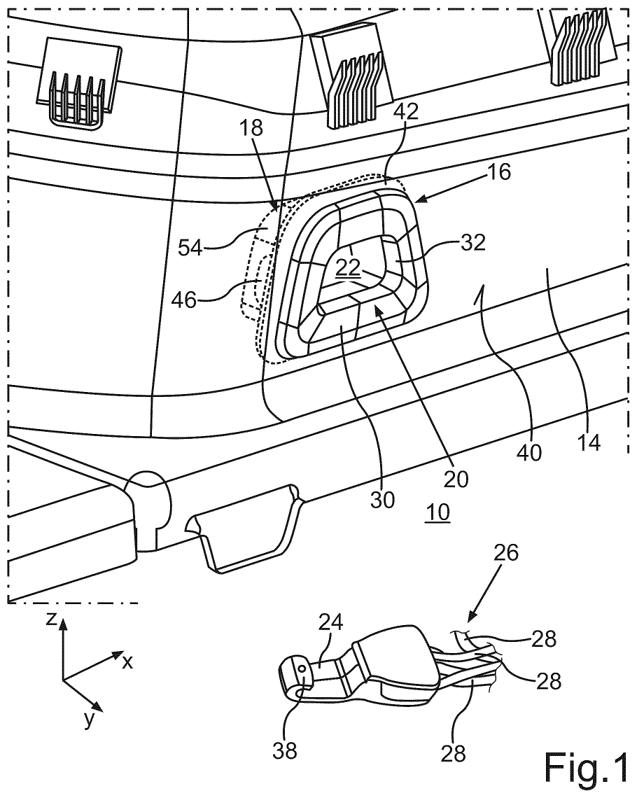

FIG. 1 shows a partial view of a cargo space 10 of a motor vehicle 12 (compare FIG. 8). In FIG. 1 and FIG. 8, the vehicle longitudinal axis x, transverse axis y and vertical axis z are illustrated by a respective coordinate system. Accordingly, the cargo space 10 is laterally limited, i.e. in the direction of the vehicle transverse axis y, by side covering parts 14. FIG. 1 shows a partial region of the left side covering part 14 in the direction of travel when the motor vehicle 12 is moving forward. In the region of the side covering part 14, the motor vehicle 12 has a holding device 16 which comprises a base part 18 and a cover part 20 held on the base part 18.

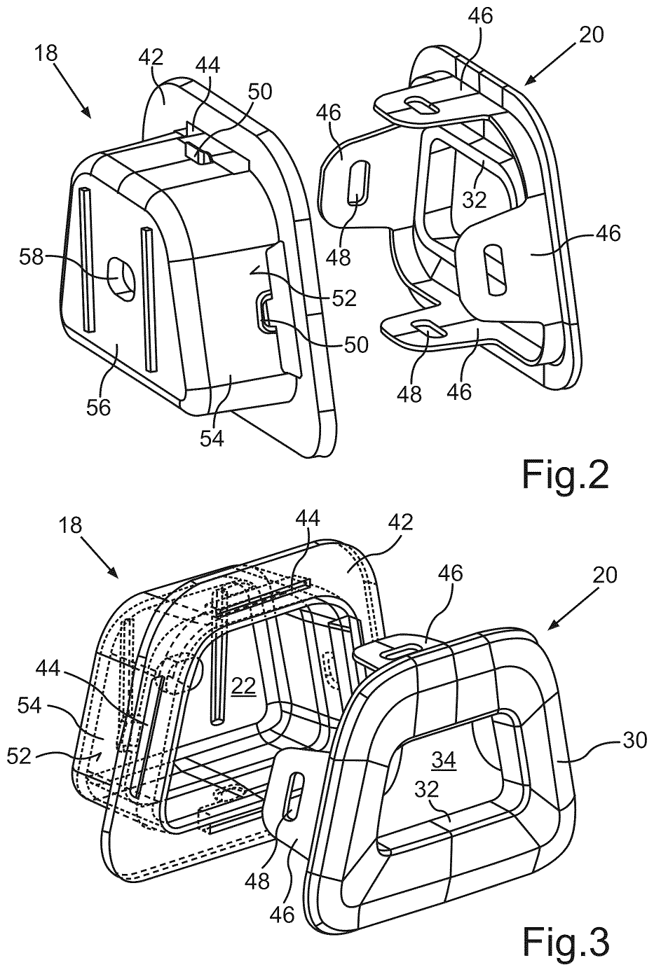

The base part 18 and the cover part 20 are shown in a perspective exploded view in FIG. 2 and in FIG. 3. According to FIG. 3, a receiving space 22 is formed in the base part 18, into which a hook 24 of a luggage net 26 (compare FIG. 1) can be inserted. For the sake of clarity, only individual cords 28 of the luggage net 26, which form the actual net, are partially shown in FIG. 1. However, the following statements apply analogously if the hook 24 is arranged on a strap or similar flexible textile element.

According to FIG. 1, the cover part 20 is held on the base part 18, wherein, in the installed state of the holding device 16, a panel region 30 of the cover part 20 in regions conceals the base part 18 behind it.

In particular, a comparison of FIG. 1 with FIG. 2 shows that the cover part 20 has a holding web 32 which, according to FIG. 2, surrounds a passage opening 34 formed in the cover part 20 (compare FIG. 3 and FIG. 6). To secure the luggage net 26 to the holding device 16, this holding web 32 can be engaged from behind by the hook 24.

For this purpose, the hook 24 must first be inserted a short distance into the receiving space 22, which is formed in the base part 18. A corresponding insertion direction 36, into which the hook 24 can be inserted into the receiving space 22 of the base part 10, is illustrated in FIG. 5 by an arrow. When a free end 38 of the hook 24 (compare FIG. 1) engages behind the holding web 32, the hook 24 is attached to the holding device 16.

According to FIG. 1, in the installation state in which the holding device 16 is installed in the motor vehicle 12, the panel region 30 of the cover part 20 is located on a front side or visible side 40 of the side covering part 14. In contrast, an edge flange 42 of the base part 18 rests against a (in this case not provided with a reference numeral) rear side of the side covering part 14. A partial region of the side covering part 14, in which a receiving opening for the base part 18 and the cover part 20 is formed, is thus received or arranged between the edge flange 42 of the base part 18 and the panel region 30 of the cover part 20. In particular, the partial region of the side covering part 14 may be clamped between the edge flange 42 and the panel region 30.

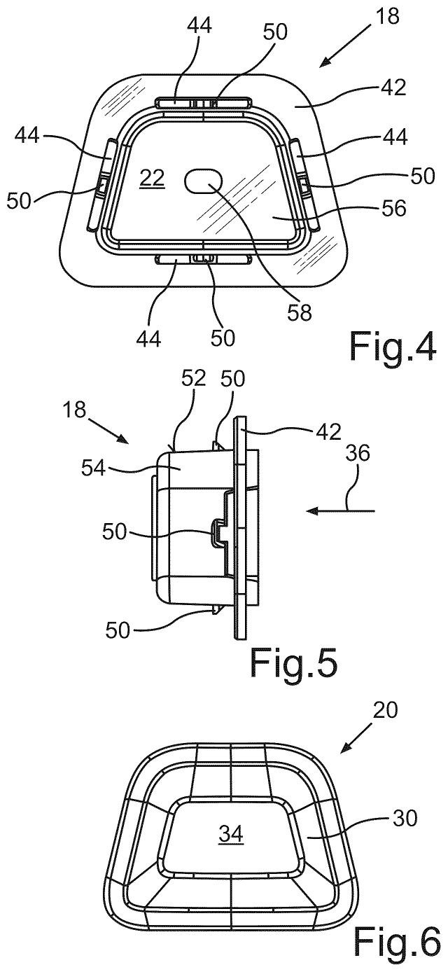

This clamping can be caused in particular by the fact that the cover part 20, as shown by way of example here, is held on the base part 18 by snapping. For this purpose, the base part 18, in the embodiment shown as an example in the figures, has a plurality of slots 44 which are formed in the edge flange 42 (compare FIG. 4).

In the exemplary embodiment of the holding device 16 shown in the figures, the receiving space 22 has a contour which is shaped in the manner of an isosceles trapezoid. However, any other forms of the receiving space 22 and thus of the base part 18 are also possible, which do not need to be explained in more detail here.

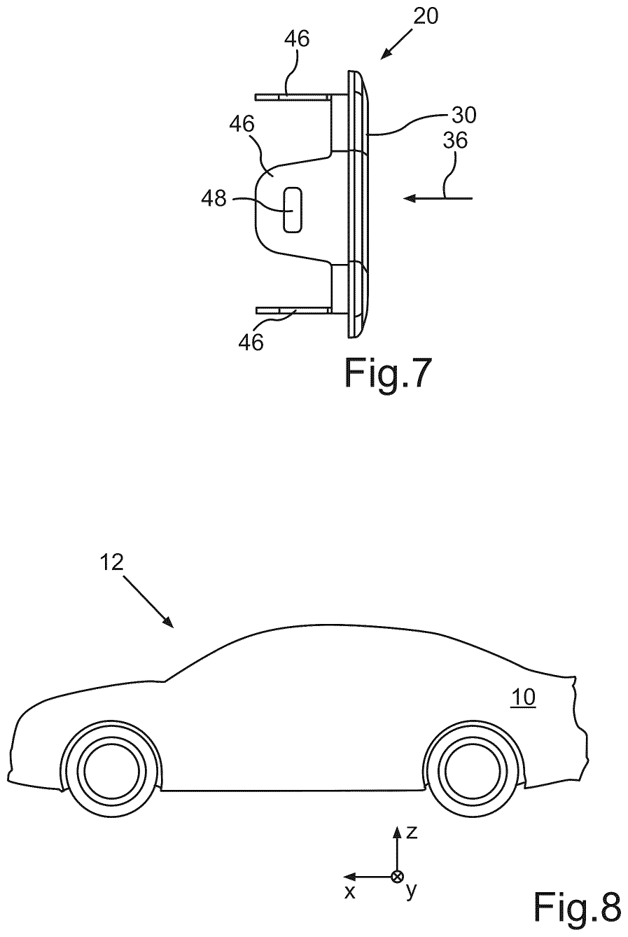

In the variant of the holding device 16 shown as an example in the figures, four slots 44 are formed in the edge flange 42 surrounding the receiving space 22, namely one slot 44 on each side of the receiving space 22, which in this case has four corner regions. Four corresponding holding tabs 46 of the cover part 20 can be inserted into these slots 44 in order to hold or fix the cover part 20 to the base part 18 by snapping it into place. The protrusion of the holding tabs 46 from the panel region 30 of the cover part 20 in the insertion direction 36 is particularly evident from FIG. 7.

When the holding tabs 46 are inserted sufficiently far into the respective slots 44, the corresponding locking elements formed on the base part 18 and the cover part 20 engage with each other. In the exemplary variant of the holding device 16 shown in the figures, the locking elements of the holding tabs 46 are designed as locking openings 48 and the locking elements of the base part 18 as locking lugs 50. One possible shape of the locking lugs 50, which can have flanks that rise obliquely in the insertion direction 36 and then drop vertically, is particularly evident from the side view of the base part 18 in FIG. 5.

In particular, it can be seen from FIG. 2 and FIG. 5 that the locking lugs 50 are arranged on an outer side 52 of a sleeve region 54 of the base part 18 which limits the receiving space 22 in the circumferential direction. In particular, the locking lugs 50 are formed integrally with the sleeve region 54.

In the insertion direction 36 (compare FIG. 5) the receiving space 22 is limited in this case by a bottom region 56 of the base part 18. In particular, it can be seen from FIG. 2 and FIG. 4 that a fastening opening 58 is formed in the base region 56, through which a fastening element, for example in the form of a fastening screw, can be passed. The basic part 18 can thus be very easily attached to a (not shown in detail here) raw component of the motor vehicle 12.

However, even if the base part 18 and the cover part 20 are only fixed to the side covering part 14, the holding device 16 can be used effectively to provide a comparatively robust and durable support for the hook 24.

The holding device 16 can be provided particularly easily if the base part 18 and the cover part 20 are pre-assembled on the side covering part 14. A correspondingly pre-assembled assembly can be delivered during the assembly of the motor vehicle 12 and then attached to the body shell of the motor vehicle 12, for example by clipping the assembly to the body shell. Then, in the region of the cargo space 10 of the motor vehicle 12 (compare FIG. 8), the holding device 16 is provided so that the hook 24 of the luggage net 26 can be hooked onto the holding web 32 of the cover part 20.

The base part 18 and the cover part 20 can be made from a respective plastic in a particularly cost-effective manner. And by snapping the cover part 20 onto the base part 18, the holding device 16 can be provided with very little effort.

Overall, the examples show how the holding device 16 can provide a cost-effective alternative to a lashing ring in the motor vehicle 12.

1. A holding device for a motor vehicle on which a hook of a luggage net for the motor vehicle can be attached, the holding device comprises: a base part and a cover part, wherein the cover part is held on the base part and at least in regions covers the base part, and wherein the base part has a receiving space into which the hook of the luggage net can be inserted,
wherein the cover part has a holding web which at least in regions surrounds a passage opening formed in the cover part, wherein the holding web can be engaged from the back by the hook of the luggage net to secure the luggage net to the holding device.

2. The holding device according to claim 1, wherein the cover part is held by snapping it onto the base part, wherein the base part has at least one slot into which a holding tab of the cover part is inserted, and wherein the base part and the holding tab have corresponding locking elements which are in engagement with each other.

3. The holding device according to claim 2, wherein the base part has a plurality of slots which are formed in a circumferential edge flange of the base part around the receiving space, wherein the locking elements of the base part are arranged on an outer side of a sleeve region of the base part which limits the receiving space in the circumferential direction.

4. The holding device according to claim 3, wherein the cover part comprises a panel region covering the slots, wherein a partial region of a covering part for the motor vehicle is arranged between the edge flange of the base part and the panel region of the cover part, and wherein the partial region of the covering part arranged between the edge flange and the panel region surrounds a receiving opening which is formed in the covering part.

5. The holding device according to claim 3, wherein the holding web of the cover part completely surrounds the passage opening formed in the cover part, wherein a free end of the hook can be inserted into a guide groove which is formed between the holding web and the sleeve region of the base part.

6. The holding device according to claim 2, wherein the corresponding locking elements comprise a locking opening formed in the holding tab and a locking lug arranged on the base part.

7. The holding device according to claim 1, wherein the receiving space of the base part is limited in an insertion direction in which the hook can be inserted into the receiving space through a bottom region of the base part.

8. The holding device according to claim 7, wherein in the bottom region of the base part at least one fastening opening is formed into which a fastening element can be inserted, wherein the base part can be fixed to a component of the motor vehicle by means of the at least one fastening element.

9. A motor vehicle with at least one holding device according to claim 1, wherein at least one receiving opening is formed in a covering part of the motor vehicle, and wherein an edge of the receiving opening surrounds the receiving space of the base part of the at least one holding device in a circumferential direction.

10. The motor vehicle according to claim 9, wherein the covering panel is designed as a side covering panel of a cargo space of the motor vehicle.

11. The holding device according to claim 4, wherein the holding web of the cover part completely surrounds the passage opening formed in the cover part, wherein a free end of the hook can be inserted into a guide groove which is formed between the holding web and the sleeve region of the base part.

12. The holding device according to claim 3, wherein the corresponding locking elements comprise a locking opening formed in the holding tab and a locking lug arranged on the base part.

13. The holding device according to claim 4, wherein the corresponding locking elements comprise a locking opening formed in the holding tab and a locking lug arranged on the base part.

14. The holding device according to claim 5, wherein the corresponding locking elements comprise a locking opening formed in the holding tab and a locking lug arranged on the base part.

15. The holding device according to claim 2, wherein the receiving space of the base part is limited in an insertion direction in which the hook can be inserted into the receiving space through a bottom region of the base part.

16. The holding device according to claim 3, wherein the receiving space of the base part is limited in an insertion direction in which the hook can be inserted into the receiving space through a bottom region of the base part.

17. The holding device according to claim 4, wherein the receiving space of the base part is limited in an insertion direction in which the hook can be inserted into the receiving space through a bottom region of the base part.

18. The holding device according to claim 5, wherein the receiving space of the base part is limited in an insertion direction in which the hook can be inserted into the receiving space through a bottom region of the base part.

19. The holding device according to claim 6, wherein the receiving space of the base part is limited in an insertion direction in which the hook can be inserted into the receiving space through a bottom region of the base part.

20. The holding device according to claim 7, wherein the receiving space of the base part is limited in an insertion direction in which the hook can be inserted into the receiving space through a bottom region of the base part.
